(19) United States
(12) Patent Application Publication
(10) Pub. No.: US 2011/0107034 A1
(43) Pub. Date: May 5, 2011

(54) CACHE DEVICE

(75) Inventor: Takeshi TANAKA, Kanagawa (JP)

(73) Assignee: Renesas Electronics Corporation

(21) Appl. No.: 12/917,926

(22) Filed: Nov. 2, 2010

(30) Foreign Application Priority Data
Nov. 4, 2009 (JP) 2009-253289

(51) Int. Cl. G06F 12/08

(52) U.S. Cl. 711/144; 711/E12.037

(57) ABSTRACT

A cache device comprises: data memory that includes a plurality of ways for storing a part of data of a main memory; tag memory that includes a plurality of ways, each of which is for storing tag contained in address of data recorded in each way of the data memory; comparison circuit that decides whether tag contained in address to be accessed agrees with the tag recorded in the tag memory or not; next address generation circuit that calculates address to be accessed next time as second address by referring to first address to be accessed at present time; and tag reading control circuit that pre-reads tag corresponding to index of the second address from the tag memory and ceases to read tags hereafter from the tag memory in a case where the tag contained in the second address agrees with the pre-read tag.

### REFERENCE TO RELATED APPLICATION

This application is based upon and claims the benefit of the priority of Japanese patent application No. 2009-253289, filed on Nov. 4, 2009, the disclosure of which is incorporated herein in its entirety by reference thereto.

### TECHNICAL FIELD

This invention relates to a cache device, and particularly relates to a cache device built in a CPU.

### BACKGROUND

When a cache device built in a CPU is accessed, the access is made to a tag memory and a data memory mounted on the cache device. Since a response speed of the tag memory and the data memory in the cache device influences the process performance of the device in general, a high-speed memory such as an SRAM is used for these memories.

It is well known that a number of accesses to the cache device and bit numbers of the accesses cause a proportional increase of electrical power consumption. In addition, a direct mapped cache system is now being replaced by a set associative cache system having several ways to improve a hit rate of the cache device, which causes more increase of power consumption of the cache device due to enlargement of a circuit scale of the memory. A request to suppress the electrical power consumption of the cache device is now increasing for extending a continuous usage time of a digital mobile device such as a mobile phone, personal digital assistant (PDA) or digital camera with such a cache device.

FIG. 6 is a block diagram illustrating a structure of a cache system described in Patent Document 1. Referring to FIG. 6, the cache system comprises: a data memory 30 storing a part of data of a main memory 10; a tag memory 22 for storing address information (tag) ADD-TAG of the data stored in the data memory 30 and an effective data bit VB that indicates whether the address information ADD-TAG is effective or not; a comparison circuit 24 for comparing an address of an object to be accessed and the address information ADD-TAG read from the tag memory 22; a hit determination unit 23 consisted of a selector SEL and a logical product 26; and a cache controller 20. In the tag memory 22, the address information commonly controls a plurality of data of continuous addresses and a plurality of the effective data bit are provided so as to correspond to the plurality of data.

In a first case where the address to be accessed corresponds to a data controlled by the same address information in the tag memory as a just previous address to be accessed, the cache controller 20 prohibits from reading from the tag memory 22 and makes a cache-hit determination based on the effective data bit VB. In a second case where the address to be accessed corresponds to a data controlled by different address information in the tag memory from a just previous address to be accessed, the cache controller 20 permits reading from the tag memory 22 and makes a cache-hit determination. When it was decided as a cache miss by the cache-hit determination, the cache controller 20 transfers a part of the plurality of data to be accessed from the main memory 10 to the data memory 30 and updates the corresponding effective data bit VB.

A CPU has an integer unit IU such as an arithmetic unit, a cache system and a bus interface unit BIU therein. The integer unit IU requests to access to the memory by outputting an address 21 to an internal address bus IA. The bus interface unit BIU accesses to the main memory 10, reads the data to be accessed, writes the data into the data memory 30 in the cache system and updates the address information in the tag memory 22. The address information ADD-TAG of a data possessed in the data memory 30 is recorded in the tag memory 22, and the one-line address information ADD-TAG in the tag memory 22 commonly controls 4-word data 30A and 3013.

Therefore, when the 4-word data 30A and 30B are accessed in turn, the address information ADD-TAG (upper address IA [31:10]) read from the tag memory 22 becomes the same every time, hence an output from the comparison circuit 24 becomes the same every time. When the data (4-word data) under control of the address information in the tag memory 22 are accessed, the address information read from the tag memory 22 become the same, hence the output from the comparison circuit 24 become the same.

When the address to be accessed corresponds to a data controlled by the same address information in the tag memory as a just previous address to be accessed, reading from the tag memory 22 is prohibited for that reason. On the other hand, when the address to be accessed corresponds to a data controlled by different address information in the tag memory from a just previous address to be accessed, the tag memory 22 is read and a cache-hit determination is made.

FIG. 7 is a timing chart illustrating an operation of the cache system described in Patent Document 1. The “address” in FIG. 7 indicates an address 21 output to the internal address bus IA. The “tag” in FIG. 7 indicates an access to the address information ADD-TAG in the tag memory 22. The “data” in FIG. 7 indicates an access to the 4-word data 30A and 30B in the data memory 30. Each of the address group 0x0 to 0xc, 0x10 to 0x1c, and 0x20 to 0x2c, respectively, is controlled by a single tag.

When the address is 0x0, because the address to be accessed is controlled by a different tag from that of just previous address to be accessed, the tag memory 22 is accessed. Then the address information ADD-TAG read by the access to the tag memory 22 is compared with upper bits (IA [31:10]) of the address 0x0. In a case where they agree, which is a hit, the data of the address 0x0 is output by an access to the data memory 30 concurrently made with the access to the tag memory 22.

When the address is 0x4, because the just previous address to be accessed 0x0 is controlled by the same tag, the tag memory 22 is not accessed, and the data of the address 0x4 is output by the access to the data memory 30. In a case where the address 0x8 or 0xc is selected, the tag memory 22 is not accessed and only data memory 30 is accessed in the same manner.

When the address is 0x10, because the address to be accessed is controlled by a different tag from that of just previous address to be accessed, the tag memory 22 is accessed. Then the address information ADD-TAG read by the access to the tag memory 22 is compared with upper bits (IA [31:10]) of the address 0x10. In a case where they agree, which is a hit, the data of the address 0x10 is output by an access to the data memory 30 concurrently made with the access to the tag memory 22.

Patent Document 2 describes a cache memory control device for decreasing power consumption of a cache memory and for improving processing efficiency.

### [Patent Document 1]

Japanese Patent Kokai Publication No. JP-P2002-063073A

### [Patent Document 2]

Japanese Patent Kohyo Publication No. JP-P2005-084999A

### SUMMARY

The disclosures of the above Patent Documents are incorporated herein by reference thereto. Now, the following analyses are given by the present invention.

According to a cache system described in Patent Document 1, the comparison circuit 24 reads from the tag memory 22 for the address to be accessed by each access request of the memory and makes a hit determination by comparing with the address to be accessed. A necessary data can be output to an external device such as a CPU immediately after the hit determination that the data agrees with the address to be accessed by reading the data in the data memory 30 concurrently.

For applying the direct mapped type cache device described in Patent Document 1 to a set associative type cache device structured by multi-way architecture, data memories 30 of all of the ways should be read at a timing of hit determination. Therefore, there is a problem that much power is consumed.

Therefore, there is a need in the art to provide a cache device in order to reduce the number of accesses to a tag memory (or the number of accesses to a tag memory and a data memory) in a set associative cache device is reduced.

According to a first aspect of the present invention, there is provided a cache device comprising:

a data memory that includes a plurality of ways for storing a part of data of a main memory;
a tag memory that includes a plurality of ways, each of which is for storing a tag contained in an address of data recorded in each way of the data memory;
a comparison circuit that decides whether a tag contained in an address to be accessed agrees with the tag recorded in the tag memory or not;
a next address generation circuit that calculates an address to be accessed next time as a second address by referring to a first address to be accessed at present time; and
a tag reading control circuit that pre-reads a tag corresponding to an index of the second address from the tag memory and ceases to read tags hereafter from the tag memory in a case where the tag contained in the second address agrees with the pre-read tag.

The present invention provides the following advantage, but not restricted thereto. According to the set associative type cache device of the present invention, the number of accesses to the tag memory can be reduced.

### BRIEF DESCRIPTION OF THE DRAWINGS

FIG. 1 is a block diagram illustrating a structure of a cache device according to a first exemplary embodiment.

FIG. 2 is a timing chart illustrating an operation of a cache device according to the first exemplary embodiment.

FIG. 3 is a block diagram illustrating a structure of a tag reading control circuit of a cache device according to a first exemplary embodiment.

FIG. 4 is a block diagram illustrating a structure of a cache device according to a second exemplary embodiment.

FIG. 5 is a timing chart illustrating an operation of a cache device according to the second exemplary embodiment.

FIG. 6 is a block diagram illustrating a structure of a conventional cache device.

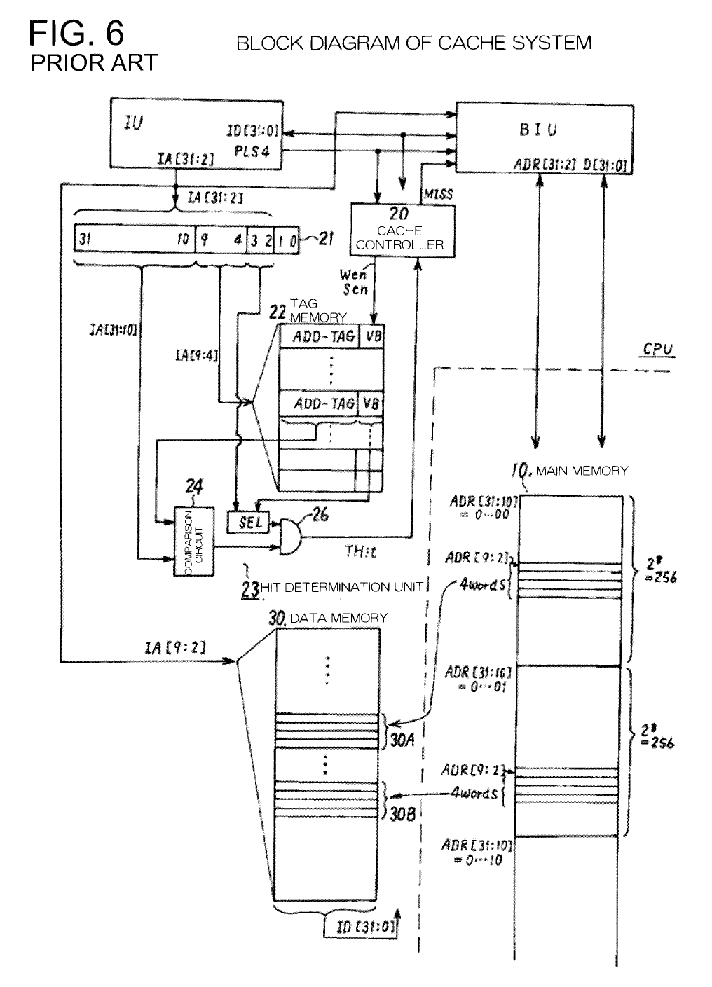

FIG. 7 is a timing chart illustrating an operation of a conventional cache device.

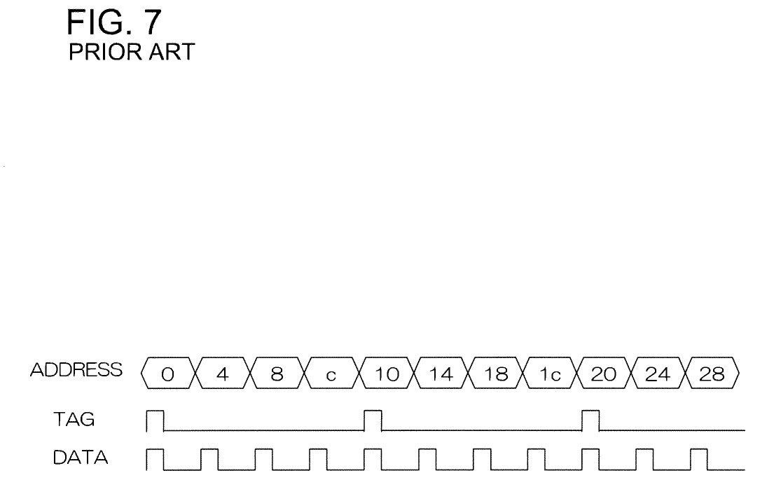

### PREFERRED MODES

In the present disclosure, there are various possible modes, which include the following, but not restricted thereto.

A cache device of a mode is preferably the cache device according to the first aspect of the present invention.

According to a cache device of a second mode, preferably the tag reading control circuit pre-reads the tag corresponding to an index of the second address from the tag memory while accesses a word controlled by the same tag being accessed.

According to a cache device of a third mode, preferably the next address generation circuit calculates the second address based on the first address and the number of words contained in one line.

According to a cache device of a fourth mode, preferably the cache device further comprises a way memory circuit that stores a way, in which a tag that agrees with the tag contained in the second address is recorded, among a plurality of ways contained in the tag memory, as a piece of way information.

According to a cache device of a fifth mode, the way memory circuit comprises: a next address way memory circuit that stores the piece of way information; and

a present address way memory circuit that stores the piece of way information recorded in the next address way memory circuit when the value of the index is changed and for outputting the piece of way information as a selection signal when reading a data from the data memory.

According to a cache device of a sixth mode, preferably the cache device further comprises a data reading control circuit that reads data from only a part of the ways in the data memory in referring to the piece of way information recorded in the present address way memory circuit.

According to a cache device of a seventh mode, each of the plurality of ways contained in the tag memory stores an effective data bit indicating whether the tag stored in each way itself is effective or not.

According to a cache device of a eighth mode, the cache device further comprises a present address portion that stores the first address.

According to a cache device of a ninth mode, the cache device further comprises next address portion that stores the second address.

According to the cache device described above, the number of accesses to a tag memory or the number of accesses to a tag memory and a data memory in the cache device of a set associative architecture can be reduced.

### Exemplary Embodiment 1

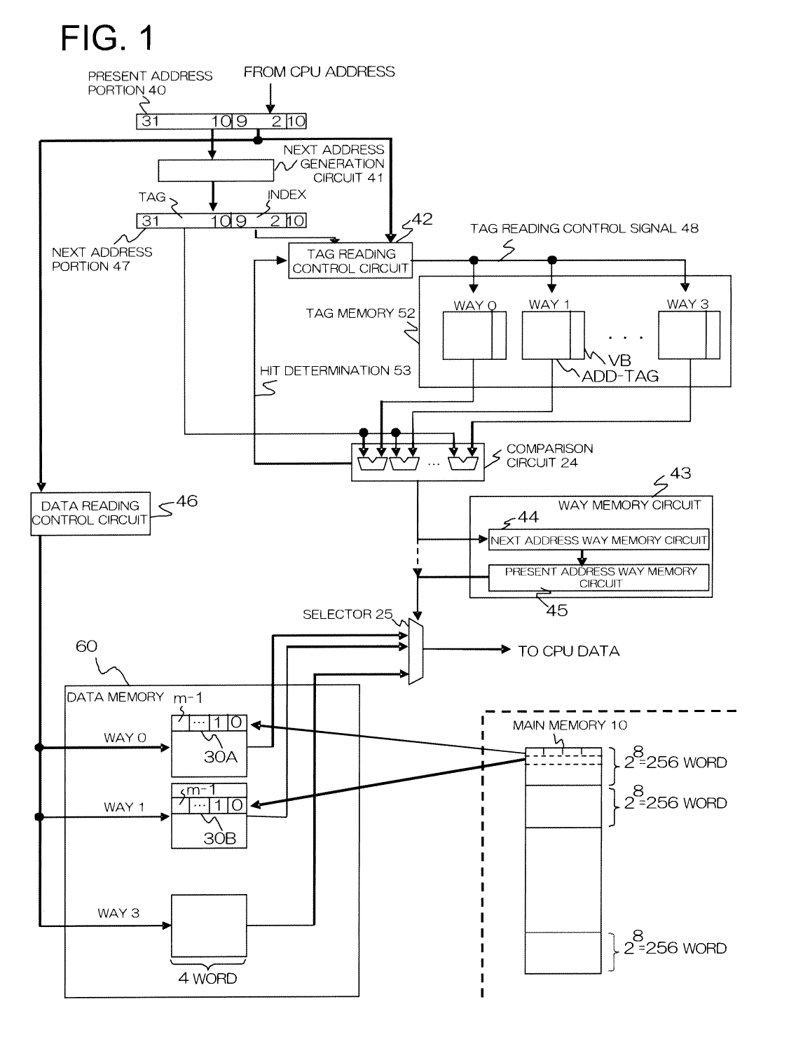

A cache device according to a first exemplary embodiment is described with reference to the drawings. FIG. 1 is a block diagram illustrating a structure of a cache device according to the present exemplary embodiment. The cache device of the present embodiment has a 4-way set associative architecture, in which one line has four words. However, the number of words in one line (or one block) and the number of ways are not limited to those values.

Referring to FIG. 1, the cache device comprises a data memory 60, a tag memory 52, a comparison circuit 24, a next address generation circuit 41, a next address portion 47, a tag reading control circuit 42, a way memory circuit 43, a data reading control circuit 46, and a selector 25.

The data memory 60 contains four ways for storing a part of data of a main memory 10.

The tag memory 52 contains four ways for storing address information (tag) ADD-TAG of data stored in the data memory 60 and an effective data bit VB that indicates whether the address information ADD-TAG is effective or not.

The comparison circuit 24 compares a tag contained in an address to be accessed with the address information (tag) read from the tag memory 52.

A present address portion 40 stores an address to be accessed at the present time based on an address of a CPU. The next address generation circuit 41 calculates an address to be accessed next time from the address to be accessed at the present time. The next address portion 47 stores the address to be accessed next time.

The tag reading control circuit 42 pre-reads a tag corresponding to an index contained in the address to be accessed next time, and when the tag is hit, that is, the pre-read tag agrees with the tag contained in the address to be accessed next time, the tag reading control circuit 42 does not read tags hereafter from the tag memory 52.

The way memory circuit 43 comprises: a next address way memory circuit 44 for storing way information hit in the index to be accessed next time; and a present address way memory circuit 45 for storing way information hit in the index to be accessed at the present time.

The data reading control circuit 46 reads data only from the hit way among the plurality of ways of the data memory 60.

The selector 25 outputs data output from one way among the plurality of ways of the data memory 60 as data to the CPU.

Referring to FIG. 1, four times of data reading is necessary to obtain information in one line (four words are contained in one line) of way information stored in the data memory 60.

The tag reading control circuit 42 reads four ways in the tag memory 52 during a reading period for one line of the data memory 60 by reading the tag memory 52 way by way at each time of the data reading above explained.

The tag reading control circuit 42 reads the tag memory 52 way by way. When the result of the reading from the tag memory agrees with the next address, the comparison circuit 24 makes a hit determination 53 in active state and the tag reading control circuit 42 does not read the tag memory 52 for ways hereafter. The next address way memory circuit 44 of the way memory circuit 43 stores way information of the hit way. When the address of the tag is accessed, the next address way memory circuit 44 transfers the way information stored in the next address way memory circuit 44 to the present address way memory circuit 45.

The data reading control circuit 46 reads only data memory 60 of the hit way by referring to the way information of the present address way memory circuit 45.

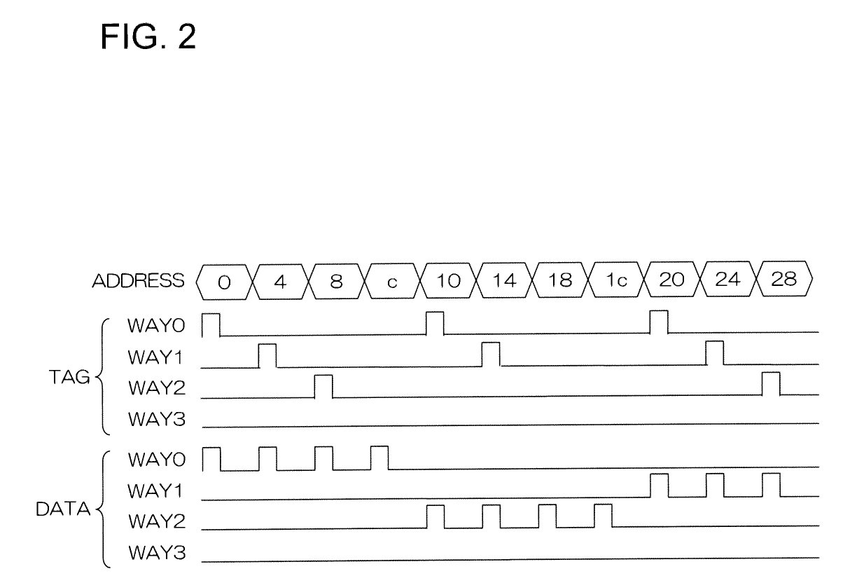

FIG. 2 shows an example of an operation of a 4-way set associative cache having four words in one line. Here, it is assumed that it is already known from a just previous cycle that when accessing to an address 0x0, a way 0 hits.

Because the next tag to be accessed has an access unit of four words, the address number becomes 0x10 and therefore the address number 0x10 is set in the next address portion 47.

When accessing to the address number 0x0, only the data stored in the way 0 is read. At the same time of the data reading, a tag of the way 0 of the address number 0x10 stored in the next address portion 47 is read and decided whether the tag is hit or not. When the tag is not hit, the next way will be compared at the next address reading time.

When accessing to the address number 0x4, only the data stored in the way 0 is read. At the same time of the data reading, a tag of the way 1 of the address number 0x10 stored in the next address portion 47 is read and decided whether the tag is hit or not. When the tag is not hit, the next way will be compared at the next address reading time.

When accessing to the address number 0x8, only the data stored in the way 0 is read. At the same time of the data reading, a tag of the way 2 of the address number 0x10 stored in the next address portion 47 is read and decided whether the tag is hit or not. When the tag is hit, it is decided that the address number 0x10 hits the way 2 and the way 2 is stored in the next address way memory circuit 44 of the way memory circuit 43.

When accessing to the address number 0xc, only the data stored in the way 0 is read. Because it has already been decided that the address number 0x10 stored in the next address portion 47 hits the way 2, the tag is not read.

It has already been known that the way 2 is hit when accessing to the address number 0x10, hence only the data of way 2 will be read when reading of the address numbers of 0x10, 0x14, 0x18 and 0x1c.

The tag reading operation is performed in the following manner. An address number 0x20 is stored in the next address portion 47. When reading the address number 0x10, a tag of way 0 of the address number 0x20 stored in the next address portion 47 is read and decided whether the tag is hit or not. When the tag is not hit, a tag of way 1 of the address number 0x20 stored in the next address portion 47 is read at the time of reading of the address number 0x14 and decided whether the tag is hit or not. When the tag is hit, the way 1 is stored in the next address way memory circuit 44 of the way memory circuit 43 and no tag reading is performed at the time of reading of address numbers 0x18 and 0x1c.

Similarly, it has already been known that the way 1 is hit when accessing to the address number 0x20, hence only the data of way 1 will be read when reading of the address numbers of 0x20, 0x24, 0x28 and 0x2c.

The tag reading operation is performed in the following manner. An address number 0x30 is stored in the next address portion 47. When reading the address number 0x20, a tag of way 0 of the address number 0x30 stored in the next address portion 47 is read and decided whether the tag is hit or not. When the tag is not hit, a tag of way 1 of the address number 0x30 stored in the next address portion 47 is read at the time of reading of the address number 0x24 and decided whether the tag is hit or not. When the tag is not hit, a tag of way 2 of the address number 0x30 stored in the next address portion 47 is read at the time of reading of the 0x28 and decided whether the tag is hit or not.

The tag is read way by way, for example, when accessing to the address number 0x0, the way 0 of the address number 0x10 is read and when accessing to the address number 0x4, the way 1 of the address number 0x10 is read. In FIG. 1, the data of the address number 0x10 is stored in the way 2 of the tag memory 52 and the data is hit by the tag reading of the way 2. Therefore, the tag of way 3 of the tag memory 52 is not read. And when the address number 0x10 is accessed, the data of the way 2 is read and, at the same time, the tag of the way 0 of the address number 0x20 to be accessed next time is read. The data of the ways 0, 1 and 3 of the data memory 60 need not to be read.

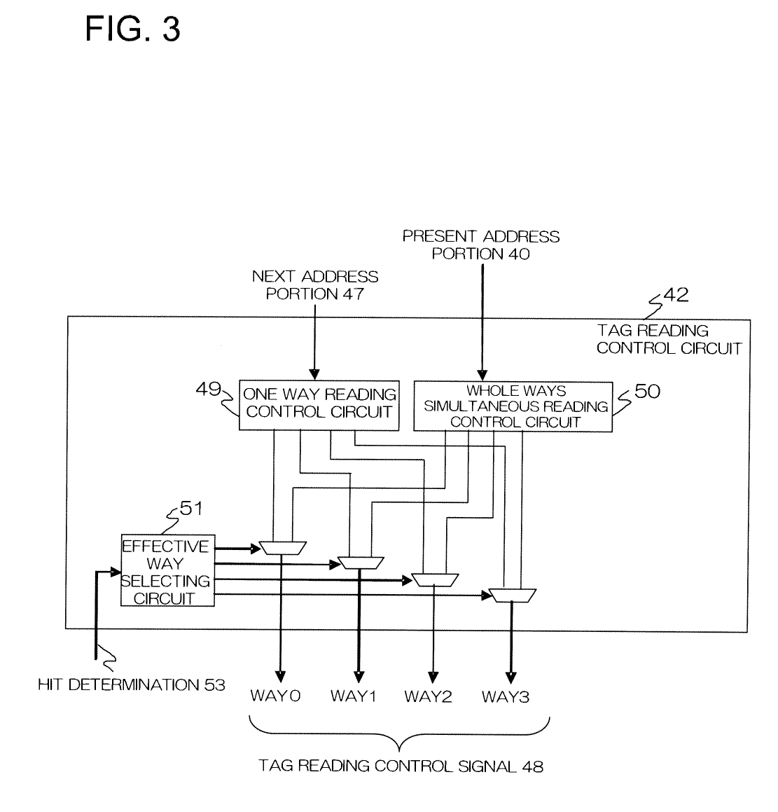

FIG. 3 is a block diagram of the tag reading control circuit 42 of the cache device according to the present exemplary embodiment. The tag reading control circuit 42 receives a present address portion 40, a next address portion 47, and a hit determination 53, and outputs a tag reading control signal 48. Referring to FIG. 3, the tag reading control circuit 42 has a whole ways simultaneous reading control circuit 50, a one way reading control circuit 49 and an effective way selection circuit 51.

In a case where a way is not found to be hit initially, the whole ways simultaneous reading control circuit 50 asserts the tag reading control signals 48 for all of the ways by a signal from the present address portion 40.

The one way reading control circuit 49 asserts the tag reading control signal 48 for a part of the ways of the next address portion 47 during the data reading operation. When it is not hit, the one way reading control circuit 49 asserts the tag reading control signal 48 for the next way, and repeats the step. When it is hit, the one way reading control circuit 49 asserts the hit determination 53 and prohibits the access to the way hereafter.

As for a cache device of n-way set associative system having m-words in one line, the same operation as the 4-words/4-way set associative cache device of the present exemplary embodiment can be realized by having the tag reading control circuit 42 to read the tag memory 52 by (n/m) ways at every data reading time.

According to a cache memory described in Patent Document 1, data of all ways should be always read when accessing to an address whose index has changed.

On the other hand, according to the cache memory of the present exemplary embodiment, the tag of the index was pre-read and a hit determination has been finished when accessing to an address whose index has changed. Therefore, by reading only data of the hit way, power consumption for accessing to the memory can be reduced.

According to the cache memory of the present exemplary embodiment, electric power consumption, which may increase proportionally to the number of accesses to each memory and the number of bits, can be largely reduced. The reason is as follows. An address to be accessed next time is calculated by an address accessed present time and a tag of an index to be accessed next time is pre-read. In a case where the next address hits an address information pre-read from the tag memory, a tag is not read hereafter. Information of a way hit at the index to be accessed next time and information of a way hit at the present access are stored and only data memory of a way to be hit is read.

Table 1 shows a comparison result of accesses to memories by the cache device of the present exemplary embodiment with a cache device described in Patent Document 1. Here, access bit numbers to the memory that is necessary for data reading from one line to obtain a cache hit is shown when using 4-way a set associative cache device having four words in one line as an example. It is assumed that the data is 32-bit and the tag is 22-bit.

According to a cache device of Patent Document 1, when accessing to address numbers of 0x10 to 0x1c, 312 bits in total is necessary for reading. They are for tag reading by 4-ways and for data reading by four times of 4-ways data and three times of 4-words hit data. Referring to Table 1, according to the cache device of the present exemplary embodiment, electric power consumption can be reduced by reducing the number of accesses to the memory.

TABLE 1
Comparison of Memory Accesses

| | | Difference of bit |
|---|---|---|
| | Total access | number from Patent |
| Hit way | bit number | Document 1 |
| Way 0 | 150 | 162 |
| Way 1 | 172 | 140 |
| Way 2 | 194 | 118 |
| Way 3 | 216 | 96 |

### Exemplary Embodiment 2

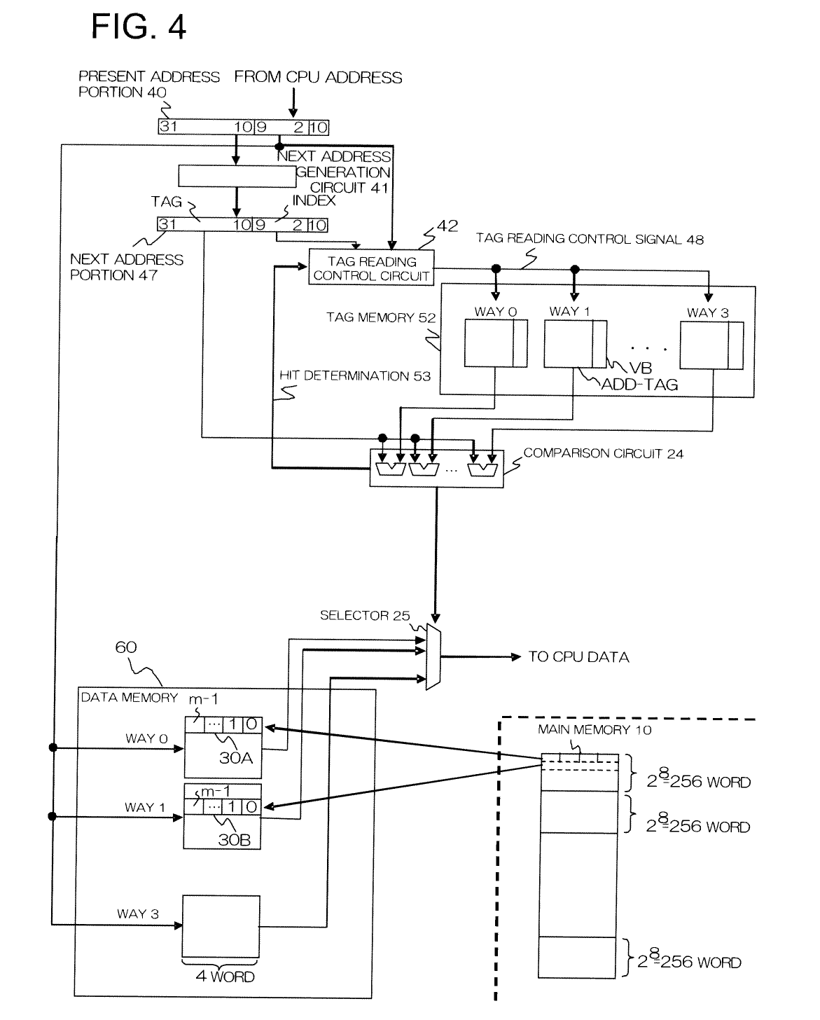

A cache device according to a second exemplary embodiment is described with reference to the drawings. FIG. 4 is a block diagram illustrating a structure of a cache device according to the present exemplary embodiment. The cache device according to the present exemplary embodiment is a 4-way set associative cache device having four words in one line (block). The structure is the same as that of the cache device according to the first exemplary embodiment (FIG. 1) from which the way memory circuit 43 (including the next address way memory circuit 44 and the present address way memory circuit 45) and the data reading control circuit 46 are excluded. However, the number of words in one line and the number of ways are not limited to those values.

Referring to FIG. 4, the cache device according to the present exemplary embodiment comprises a data memory 60, a tag memory 52, a comparison circuit 24, a next address generation circuit 41, a next address portion 47 and a tag memory reading control circuit 42.

The data memory 60 contains four ways for storing a part of data of a main memory 10.

The tag memory 52 contains four ways for storing address information (tag) ADD-TAG of data stored in the data memory 60 and an effective data hit VB that indicates whether the address information ADD-TAG is effective or not.

The comparison circuit 24 compares a tag contained in an address to be accessed with the address information (tag) read from the tag memory 52.

The next address generation circuit 41 calculates an address to be accessed next time in referring to the present address portion 40 for storing an address to be accessed this time. The next address portion 47 stores the next address.

The tag reading control circuit 42 pre-reads a tag corresponding to an index contained in the address to be accessed next time, and when the tag is hit, that is, the pre-read tag agrees with the tag contained in the address to be accessed next time, the tag reading control circuit 42 does not read tags hereafter.

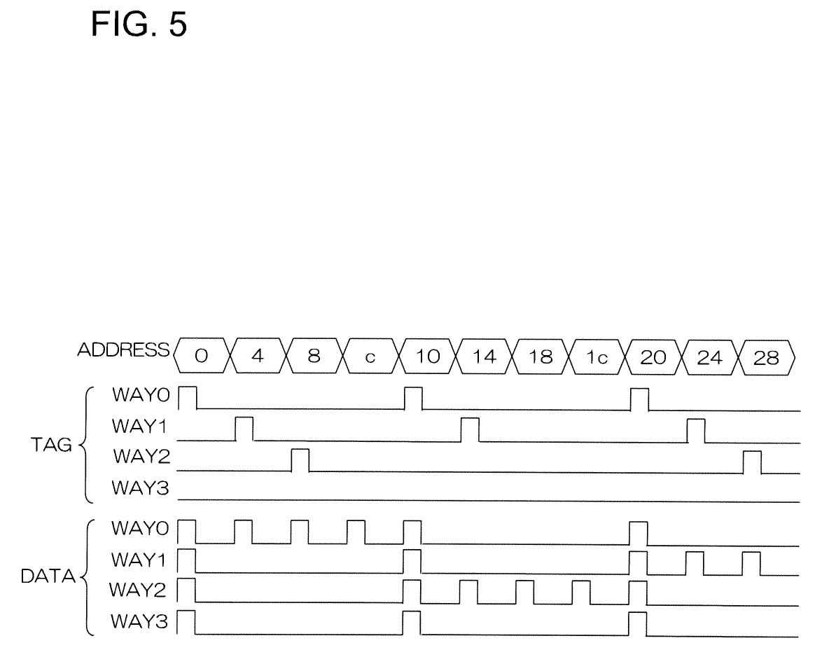

FIG. 5 is a timing chart illustrating an operation of the cache device according to the present exemplary embodiment. The cache device according to the present exemplary embodiment is a 4-way set associative cache device having four words in one line.

According to the cache device of the present exemplary embodiment, during reading and comparing the tags in order, when a tag hits before finishing comparing with all of the ways, the tag reading from the way after hitting is prohibited. Thus, the number of accesses to the memory can be reduced compared with a cache device described in Patent Document 1 which always reads tags of all ways.

According to the cache device of the present exemplary embodiment, the reading times of the tag memory 52 can be reduced by a smaller sized circuit than the first exemplary embodiment without structural restriction of the data memory 60. The reason is as follows. That is, there are some cases where the data memory of a plurality of ways is structured by a single memory as a merit of a memory circuit. For example, there is a case where the data memory 60 is structured by one or two memories instead of four memories. In such a case, although the reading times of the data memory cannot be reduced, the reading times of the tag memory 52 can be reduced.

According to the cache device of the present exemplary embodiment, the access times to the tag memory 52 can be reduced with a simple structure. The reason is that, while reading and comparing the tags in order, if a tag hits before finishing comparing with all of the ways, the tag reading from the way after hitting can be prohibited.

It should be noted that other objects, features and aspects of the present invention will become apparent in the entire disclosure and that modifications may be done without departing the gist and scope of the present invention as disclosed herein and claimed as appended herewith.

Also it should be noted that any combination or selection of the disclosed and/or claimed elements, matters and/or items may fall under the modifications aforementioned.

What is claimed is:

1. A cache device comprising:
a data memory that includes a plurality of ways for storing a part of data of a main memory;
a tag memory that includes a plurality of ways, each of which is for storing a tag contained in an address of data recorded in each way of the data memory;
a comparison circuit that decides whether a tag contained in an address to be accessed agrees with the tag recorded in the tag memory or not;
a next address generation circuit that calculates an address to be accessed next time as a second address by referring to a first address to be accessed at present time; and
a tag reading control circuit that pre-reads a tag corresponding to an index of the second address from the tag memory and ceases to read tags hereafter from the tag memory in a case where the tag contained in the second address agrees with the pre-read tag.

2. The cache device according to claim 1, wherein the tag reading control circuit pre-reads the tag corresponding to an index of the second address from the tag memory while a word controlled by the same tag being accessed.

3. The cache device according to claim 1, wherein the next address generation circuit calculates the second address based on the first address and the number of words contained in one line.

4. The cache device according to claim 2, wherein the next address generation circuit calculates the second address based on the first address and the number of words contained in one line.

5. The cache device according to claim 1, further comprising a way memory circuit that stores a way, in which a tag that agrees with the tag contained in the second address is recorded, among a plurality of ways contained in the tag memory, as a piece of way information.

6. The cache device according to claim 5, wherein the way memory circuit comprises: a next address way memory circuit that stores the piece of way information; and
a present address way memory circuit that stores the piece of way information recorded in the next address way memory circuit when the value of the index is changed and outputs the piece of way information as a selection signal when reading a data from the data memory.

7. The cache device according to claim 6, further comprising a data reading control circuit that reads data from only a part of the ways in the data memory in referring to the piece of way information recorded in the present address way memory circuit.

8. The cache device according to claim 1, wherein each of the plurality of ways contained in the tag memory stores an effective data hit indicating whether the tag stored in each way itself is effective or not.

9. The cache device according to claim 1, further comprising a present address portion that stores the first address.

10. The cache device according to claim 1, further comprising a next address portion that stores the second address.
